(19) United States
(12) Patent Application Publication
(10) Pub. No.: US 2007/0237976 A1
(43) Pub. Date: Oct. 11, 2007

(54) Surface Treated Copper Foil, Flexible Copper-Clad Laminate Manufactured Using the Same, and Film Carrier Tape

(75) Inventors: Kazuyuki Okada, Ageo-shi (JP); Masaru Takahashi, Ageo-shi (JP)

Correspondence Address: ROTHWELL, FIGG, ERNST & MANBECK, P.C., 1425 K STREET, N.W., SUITE 800, WASHINGTON, DC, 20005, US

(73) Assignee: MITSUI MINING & SMELTING CO., LTD., Tokyo (JP)

(21) Appl. No.: 11/628,446

(22) PCT Filed: Jun. 2, 2005
(86) PCT No.: PCT/JP05/10151

§ 371 Date: Apr. 11, 2007

(30) Foreign Application Priority Data
Jun. 3, 2004 (JP) 2004-166320

(51) Int. Cl. B32B 15/04

(52) U.S. Cl. 428/606

(57) ABSTRACT

An object of the invention is to provide a surface treated copper foil and the like, which ensure practically sufficient adhesion when a copper foil having no roughening treatment applied hereto is bonded with a polyimide resin substrate and which have no slip-in of plated tin. To attain the object, there is employed a surface treated copper foil for a polyimide resin substrate characterized by being an electro-deposited copper foil having a surface treatment layer for improving adhesion to the polyimide resin substrate on a shiny surface side, in which, the surface treatment layer is a nickel-zinc alloy layer or a cobalt-zinc alloy layer containing nickel or cobalt in an amount of 65 wt % to 90 wt % and zinc in an amount of 10 wt % to 35 wt % except for inevitable impurities and having a weight thickness of 30 mg/m² to 70 mg/m².

### TECHNICAL FIELD

The invention according to the present application principally relates to a surface treated copper foil. The surface treated copper foil is particularly suitable for use in laminating it directly on a polyimide resin substrate and useful for manufacturing a flexible copper-clad laminate and a film carrier tape for TAB.

### BACKGROUND ART

Copper foil, which is used by bonding it to a polyimide resin substrate, has been conventionally used by applying roughening treatment to a bonding surface, for example, by attaching fine copper particles thereto, so as to give an anchoring effect on the bonding surface and providing an adhesive layer interposed between them, as disclosed in various documents including Patent Document 1. Since such a flexible copper-clad laminate and a film carrier tape for TAB have a three layer structure consisting of, namely, a copper foil layer, an adhesive layer and a polyimide resin substrate layer, they have been called as a three-layer flexible copper-clad laminate or a three-layer film carrier tape. Note that the flexible copper-clad laminate used in the present invention is a term conceptually opposite to rigid substrates such as a glass-epoxy substrate and a paper-phenol substrate. The term collectively means all copper-clad laminates using a polyimide resin substrate. Accordingly, in a broad sense, a film carrier tape for TAB is included in the flexible copper-clad laminate. However, they are frequently used separately in the industry in some cases. Thus, they are separately described for caution's sake.

A general electro-deposited copper foil, which is used by bonding it to a polyimide resin substrate, will now be explained. A bulk copper layer used as a base of an electro-deposited copper foil is obtained by supplying a copper electrolytic solution between a rotating cathode in the drum shape and a lead-based anode, which is arranged along the shape of the rotating cathode and so as to face it, to deposit copper on the drum surface of the rotating cathode by use of an electrolytic reaction. The copper thus deposited forms foil, which is obtained by peeled off it continuously from the rotating cathode.

Onto the surface of the electro-deposited copper foil obtained and in contact with the rotating cathode, the surface shape (mirror-finish surface) of the rotating cathode is transferred. Since this surface is a glossy and smooth surface, it is called a “shiny surface”. In contrast, the surface of the electro-deposited copper foil, which is in contact with the solution and having deposit thereon, exhibits a crested and bumpy state since the crystal growth rates of copper deposition are different for every crystalline plane. This surface is called a matte surface. The matte surface is usually used as a bonding surface to an insulating material in manufacturing a copper-clad laminate. As described above, since the foil upon peeled off from the surface of the rotating cathode is not applied with any treatment such as rust proofing, it is called as a deposited foil or an untreated foil (hereinafter referred to as an “untreated foil).

The untreated foil is subjected to a surface treatment step, in which roughening treatment for forming a matte surface and rust proofing are applied. The matte surface treatment for forming a matte surface is a treatment in which fine copper particles are deposited and deposited onto the matte surface in crested and bumpy form by supplying an electric current within the so-called burning plating conditions in a copper sulfate solution, and thereafter, the matte surface is immediately clad with plating within the current range of seal plating conditions to prevent drop-off of the fine copper particles. Accordingly, the matte surface having fine copper particles deposited and adhered thereon is called as a “roughened surface”. Subsequently, rust proofing is applied to the roughened surface as needed to accomplish an electro-deposited copper foil to be delivered to the market.

Meanwhile, with a recent trend toward light-weighting and downsizing of electronic devices housing a printed wiring board and formation of advanced functional devices, requirements for improving the wiring density of the printed wiring board have been increased year by year. In addition, quality improvement as a product is required and high dimensional accuracy of a circuit shape formed by etching is required. More specifically, an etching factor for a circuit has been desired to improve up to a level such that impedance control can be completely performed.

In the circumstances, to solve such a problem of the etching factor of the circuit, an attempt has been made to obtain sufficient bonding adhesion without applying roughening treatment by providing two types of resin layers different in composition onto the surface of a copper foil having no roughening treatment applied thereto in order to ensure the adhesion to a resin substrate, as disclosed in Patent Document 2.

Furthermore, to satisfactorily maintain the shape of a circuit after etching, it has been desired to form the copper foil layer to be etched as thin as possible. To satisfy the desire, a technique for reducing the thickness of the copper foil layer (as disclosed in Patent Documents 3 and 4) has been desired. The present applicant and inventors have provided an electro-deposited copper foil provided with a carrier foil (as disclosed in Patent Document 3) on the market. The electro-deposited copper foil provided with a carrier foil is advantageous in that, since the carrier foil bonded to the electro-deposited copper foil serves as a support layer, the thickness of the copper foil layer can be easily reduced, easy-to-handle, and neither wrinkle nor stain produced on the copper foil surface. Patent Document 4 discloses that a seed layer is formed in forming a copper foil layer on the surface of a polyimide resin substrate, and then, a copper layer having an arbitrary thickness is electrolytically grown on the seed layer to form a so-called two-layer substrate. The inventions disclosed in Patent Documents 3 and 4 are advantageous in that the thickness of a copper foil layer can be controlled extremely easily.

[Patent Document 1]

Japanese Patent Laid-Open No. 05-029740

[Patent Document 2]

Japanese Patent Laid-Open No. 11-10794

[Patent Document 3]

Japanese Patent Laid-Open No. 2000-43188

[Patent Document 4]

Japanese Patent Laid-Open No. 2002-252257

### DISCLOSURE OF THE INVENTION

### Problems to be Solved by the Invention

As far as the present inventors know, however, sufficient adhesion cannot be obtained even if a copper foil having conventional roughening treatment and rust proofing applied thereto is directly bonded to a polyimide resin substrate. The peel strength of the resultant circuit is low. In addition, when the terminal portion of the circuit is plated with tin, a phenomenon where tin slips into the interface between the circuit and the polyimide resin substrate (hereinafter simply referred to as a “slip-in phenomenon of plated tin”) takes place.

Even if the copper foil provided with a resin disclosed in Patent Document 2 is used, stable adhesion to a polyimide resin substrate cannot be obtained in view of design. Besides this, even if a resin layer formed of two layers different in composition is bonded to a polyimide resin substrate, the slip-in phenomenon of plated tin takes place when tin is plated as described above.

The electro-deposited copper foil provided with a carrier foil disclosed in Patent Document 3 is advantageous in reducing in thickness of the copper foil layer. However, roughening treatment and rust proofing are performed in the same manner as in general copper foil. Accordingly, even if such an electro-deposited copper foil provided with a carrier foil is bonded directly to a polyimide resin substrate to form a two-layered substrate, sufficient adhesion cannot be obtained and the slip-in phenomenon of plated tin took place when it was plated with tin.

In the two-layer substrate obtained by the invention disclosed in Patent Document 4, adhesion between a copper foil layer and a polyimide resin substrate becomes practically sufficient by virtue of recent technical progress. Nevertheless, it is difficult to form a seed layer on the surface of a polyimide resin substrate as a stable coating film, and the resultant copper layer has many problems with defects such as pinholes and micro-porosity. Therefore, even if the thickness of the copper layer itself can be reduced, it is difficult to form a fine-pitch circuit.

As mentioned above, it is a technique, which has been studied in this field, that a copper foil having no roughening treatment applied thereto bonded to a polyimide resin substrate is used. If a product is obtained with satisfactory adhesion in practice and without the slip-in phenomenon of plated tin by bonding a copper foil having no roughening treatment applied thereto, the total manufacturing cost of a flexible printed wiring board can be reduced, and further, a fine circuit can be easily obtained. If the object can be attained by an electro-deposited copper foil provided with a carrier foil, the copper foil layer can be reduced in thickness. As a result, extraordinary large effect would be brought in the market. If the roughening treatment of a copper foil is not required, over-etching time for dissolving a rough-treatment portion is not required in etching the circuit. As a result, the total etching cost can be reduced and the etching factor of the obtained circuit may be tremendously improved.

In the meantime, it has been conventionally said that the higher the peel strength for peeling off the circuit of a printed wiring board, the better. However, recent technical improvement of etching accuracy eliminates drop off of the circuit in an etching process. In the field of the printed wiring board industry, a method of handling a printed wiring board has been established and a problem of breakage/drop off of a circuit caused by mistakenly picking up, has been overcome. Therefore, the circuit having a peel strength of not less than 0.8 kgf/cm or more when a circuit is peeled off to an angle of 90° and a peel strength of 1.5 kgf/cm or more when a circuit is peeled off to an angle of 180°, can be used in practice. No problem may be raised if not less than 1.0 kgf/cm is applied when a circuit is peeled off to an angle of 90° and not less than 1.5 kgf/cm is applied when a circuit is peeled off to an angle of 180°.

### Means for Solving the Problems

As a result of intensive studies conducted by the present inventors, they arrived at a surface treated copper foil and a surface treated copper foil provided with a carrier foil according to the present invention. The content of the present invention will be described by dividing it into the sections of “surface treated copper foil” and “surface treated copper foil provided with a carrier foil”, etc.

<A Surface Treated Copper Foil According to the Present Invention>

The surface treated copper foils according to the present invention can be roughly divided into a type (hereinafter referred to as “type I”), which has a surface treatment layer on the shiny surface of an electro-deposited copper foil, and a type (hereinafter referred to as “type II”), which has a surface treatment layer on the matte surface of the electro-deposited copper foil. The surface treated copper foils of type I according to the present invention can be further divided into two types (type Ia and type Ib) depending upon the type of surface treatment layer. Similarly, the surface treated copper foils of type II according to the present invention can be further divided into two types (type IIa and type IIb) depending upon the type of surface treatment layer. Now, these will be separately explained below.

(Type I)

The surface treated copper foil of type I has a surface treatment layer, which is provided on the shiny surface of an electro-deposited copper foil, for improving the adhesion with a polyimide resin substrate. FIG. 1 shows a schematic sectional view of the surface treated copper foil 1 of type I. As is apparent from FIG. 1, an electro-deposited copper foil 2 for manufacturing the surface treated copper foil 1 of Type I according to the present invention is intentionally used without applying roughening treatment thereto. On the smooth and glossy surface of the electro-deposited copper foil 2, a surface treatment layer 3 is provided. The surface on which the surface treatment layer 3 is provided is used as a bonding surface to the polyimide resin substrate. As the surface treatment layer, a nickel-zinc alloy layer or a cobalt-zinc alloy layer is employed.

Accordingly, one of the surface treated copper foils belonging to type I is “a surface treated copper foil for a polyimide resin substrate characterized by being an electro-deposited copper foil having a surface treatment layer for improving adhesion to the polyimide resin substrate, in which the surface treatment layer is provided on a shiny surface side of the electro-deposited copper foil and is a nickel/zinc alloy layer or a cobalt-zinc alloy layer containing nickel or cobalt in an amount of 65 wt % to 90 wt % and zinc in an amount of 10 wt % to 35 wt % except for inevitable impurities and having a weight thickness of 30 mg/m to 70 mg/m²”. This is designated as “Type Ia”.

Another surface treated copper foil belonging to type I is “a surface treated copper foil for a polyimide resin substrate characterized by being an electro-deposited copper foil having a surface treatment layer for improving adhesion with the polyimide resin substrate on the shiny surface side in which the surface treatment layer is provided at the shiny surface side of the electro-deposited copper foil and is a nickel-zinc-cobalt alloy layer satisfying the following conditions A to C”. Condition A is that “the total content of a cobalt content and a nickel content is 65 wt % to 90 wt % and a zinc content is 10 wt % to 35 wt % except for inevitable impurities”. Condition B is that “nickel is contained in the range of 10 wt % to 70 wt % and cobalt is contained in the range of 18 wt % to 72 wt %”. Condition C is that “the weight thickness of the nickel-zinc-cobalt alloy layer is 30 mg/m² to 70 mg/m²”. This is designated as “type Ib”.

In the copper foil used in type I, a surface treatment layer, which is formed on the shiny surface of the copper foil, is used as a bonding surface with a polyimide resin substrate. This is because the shiny surface of the electro-deposited copper foil does not vary depending upon the thickness of the electro-deposited copper foil. However, a flexible printed wiring board is frequently desired for forming a fine pitch circuit. In this case, an electro-deposited copper foil having a thickness of 7 μm to 35 μm is usually used. This is because it is difficult to form a copper foil having a thickness of less than 7 μm without a carrier foil. When an electro-deposited copper foil having a thickness exceeding 35 μm is used, it is difficult to form a fine circuit with a pitch of less than 80 μm. The shiny surface mentioned above more preferably has a roughness (Rzjis) of 2.0 μm or less. The shiny surface is a mirror shape of cathode surface when the electro-deposited copper foil is manufactured, and thus, determined by how to control the roughness of the cathode surface. However, to obtain the state of the shiny surface on which a fine pitch circuit can be formed as much as possible, by removing unevenness shape of the interface with the polyimide resin substrate, a roughness (Rzjis) is preferably 2.0 μm or less and more preferably 1.5 μm or less. The lowermost limit is not particularly defined; however, the roughness (Rzjis) is preferably 0.5 μm or more to ensure practical adhesion with the polyimide resin substrate.

Furthermore, the surface treatment layer of the surface treated copper foil of type I serving as a bonding surface with a polyimide resin substrate preferably has a glossiness (Gs (60°)) of 180% or less. The surface treatment layer is formed by a plating method as described later. The surface state of the deposited surface formed by plating can be controlled in a broad range from a glossy state to a delustering state. This difference is conceivably due to the state of the plated surface, that is, either an extremely smooth state or a rough state with extremely fine unevenness shapes. However, it is difficult to measure such a level of unevenness state by a roughness gage and the difference is not determined. Then, the present inventors conducted intensive studies and found that glossiness is used as a substitute index exhibiting the state of the surface. In the present invention, the glossiness (Gs (60° C.)) is defined as 180% or less. This is because if the smoothness exceeds a glossiness of 180%, the adhesion with a polyimide resin substrate is likely to vary. The lowermost value varies depending upon the manufacturing conditions for the surface treatment layer and thus is not particularly defined. In the case where the surface treatment layer is obtained by the manufacturing method described later, the lowermost value is about 25% both in type Ia and type Ib.

Surface Treatment Layer of Type Ia

Next, the surface treatment layer to be provided on the shiny surface will be explained. The surface treatment layer of type Ia is a nickel-zinc alloy layer or a cobalt-zinc alloy later containing nickel or cobalt in an amount of 65 wt % to 90 wt % and zinc in an amount of 10 wt % to 35 wt % except for inevitable impurities and having a weight thickness of 30 mg/m² to 70 mg/m². As the nickel-zinc alloy or a cobalt-zinc alloy used herein, a composition containing nickel or cobalt in an amount of 65 wt % to 90 wt % and zinc in an amount of 10 wt % to 35 wt % except for inevitable impurities is employed. The numerical value expressed by wt % value does not include that of inevitable impurities and the total of nickel or cobalt and zinc equals to 100 wt %. The reason why nickel based alloy and cobalt based alloy are employed is that the presence of nickel or cobalt improves the wettability of a polyimide resin base, improving adhesion. In particular, a nickel based alloy or a cobalt based alloy, which is employed in the surface treatment layer, functions as a barrier for preventing direct contact of copper and a polyimide resin when a flexible printed wiring board using a polyimide resin substrate is heated, and prevents deterioration of the resin due to the catalytic function of copper. Thus the nickel based alloy or the cobalt based alloy is effective in preventing a decrease of peel strength of the circuit after heating. However, excessively large content of the nickel or cobalt is not preferable, because the surface treatment layer cannot be removed with a copper etching solution.

In the case of a nickel-zinc alloy or a cobalt-zinc alloy of type Ia, a composition containing nickel or cobalt in an amount of 65 wt % to 90 wt % and zinc in an amount of 10 wt % to 35 wt % is desirably employed within the weight thickness range mentioned above. The reason why a nickel-zinc alloy or a cobalt-zinc alloy is employed is because nickel and cobalt, each of which is less soluble in a copper etching solution by itself, can be easily removed by combining zinc, which is generally called as a base metal and readily dissolved in an acid solution, to nickel or cobalt excellent in corrosion resistance. Accordingly, when the content of zinc is less than 10 wt % or less, it is difficult to dissolve a nickel-zinc alloy or a cobalt-zinc alloy with a copper etching solution, with the result that a nickel component or a cobalt component tends to remain as residual ingredient after a circuit etching process, rendering insulation between circuits insufficient to cause short-cut circuit and surface-layer migration. In contrast, when the zinc content exceeds 35 wt %, the adhesion between a surface treated copper foil and a polyimide resin substrate decreases and the slip-in phenomenon of tin is likely to occur when tin is plated. In order to prevent generation of residual ingredients more reliably when a nickel-zinc alloy composition is used, it is more preferable to employ a composition containing nickel in an amount of 66 wt % to 80 wt % and zinc in an amount of 34 wt % to 20 wt %.

To improve the adhesion with a polyimide resin substrate; at the same time, to effectively prevent the slip-in phenomenon of tin, the thickness of the surface treatment layer is a matter of concern. Now, let us consider the mechanism underling generation of the slip-in phenomenon of tin. When the circuit is etched or when it is exposed to a plating solution thereafter, an acidic solution such as an etching solution gets in the interface portion A between a circuit 4 and a polyimide resin substrate 5 as shown in FIG. 2, thereby decreasing the adhesion of the circuit. Consequently, a tin plating solution gets in the interface portion A, leading to the state where the plated tin layer 8 enters beneath the circuit 4. The surface treatment layer must have good chemical resistance, which is evaluated by an alternative method, that is, a method of evaluating resistance to hydrochloric acid or the like.

Then, according to the present invention, a weight thickness of the nickel-zinc alloy layer or the cobalt-zinc alloy layer serving as the surface treatment layer preferably falls within the range of 30 mg/m² to 70 mg/m². When the weight thickness of each of these alloy layers is less than 30 mg/m², basically good adhesion to a polyimide resin substrate cannot be obtained. When the weight thickness of each of these alloy layers exceeds 70 mg/m², these alloy layers are too thick as the surface treatment layer to maintain good chemical resistance. The chemical resistance tends to increase as the surface treatment layer formed on the copper foil becomes as thin as possible. In the case of a nickel-zinc alloy layer, the weight thickness more preferably falls within the range of 35 mg/m² to 45 mg/m². This is because the chemical resistance is stabilized when the weight thickness of the nickel-zinc alloy layer is within 45 mg/m² or less. In contrast, in the case of the cobalt-zinc alloy layer, the weight thickness more preferably falls within the range of 40 mg/m² to 70 mg/m². Furthermore, in view of stably preventing the slip-in phenomenon of plated tin, the weight thickness more preferably falls within the range of 50 mg/m² to 70 mg/m².

Surface Treatment Layer of Type Ib

The nickel-zinc-cobalt alloy layer of type Ib is required to satisfy the conditions A to C. Condition A is that “the total content of a cobalt content and a nickel content is 65 wt % to 90 wt % and a zinc content is 10 wt % to 35 wt % except for inevitable impurities”. Condition B is that “nickel is contained in the range of 10 wt % to 70 wt % and cobalt is contained in the range of 18 wt % to 72 wt %”. Condition C is that “the weight thickness of the nickel-zinc-cobalt alloy layer is 30 mg/m² to 70 mg/m²”. As the nickel-zinc-cobalt alloy, the aforementioned composition except for inevitable impurities is employed. The numerical value expressed by wt % value does not include that of inevitable impurities and the total of nickel, zinc and cobalt equals to 100 wt %. The reason why such an alloy is employed is the same as in the case of type Ia and thus further explanation is omitted herein. However, in the case of the nickel-zinc-cobalt alloy, it is not preferable that the total content of nickel and cobalt is excessively large, because the surface treatment layer cannot be removed with a copper etching solution and residual ingredients remains.

In the case of a nickel-zinc-cobalt alloy layer of type Ib, it is required (condition A) that the total content of a cobalt content and a nickel content is 65 wt % to 90 wt % and a zinc content is 10 wt % to 35 wt %. The reason why an alloy composition containing zinc is employed herein is that nickel and cobalt, each of which is less soluble in a copper etching solution by itself, can be easily dissolved and removed by combining zinc, which is generally called as a base metal and readily dissolved in an acid solution, to nickel and cobalt excellent in corrosion resistance. Accordingly, when the content of zinc is less that 10 wt %, it is difficult to dissolve a nickel-zinc-cobalt with a copper etching solution, with the result that a nickel component and cobalt component tend to remain as residual ingredients when a circuit is etched, rendering insulation between circuits insufficient to cause short-cut circuit and surface-layer migration. In contrast, when the content of zinc exceeds 35 wt %, the adhesion between a surface treated copper foil and a polyimide resin substrate decreases and the slip-in phenomenon of tin is likely to occur when tin is plated.

As to the contents of nickel and cobalt, it is desired to employ a composition containing nickel in an amount of 10 wt % to 70 wt % and cobalt in an amount of 18 wt % to 72 wt % (Condition B). When the contents deviate from these ranges, it is not rational since they fail to keep balance with the appropriate range of the zinc content mentioned above. Accordingly, when the nickel content is 10 wt %, the cobalt content is 55 wt % to 80 wt %, whereas when the nickel content is 70 wt %, the cobalt content is 18 wt % to 20 wt %. This is because when the nickel content is less than 10 wt %, no substantial difference with the case where cobalt is used alone is observed, whereas when the nickel content exceeds 70 wt %, it becomes hard to come to remove it with a copper etching solution. It is remove it

Furthermore, it is preferable in the present invention that the nickel-zinc-cobalt alloy layer serving as a surface treatment layer has a weight thickness within the range of 30 mg/m2 to 70 mg/m² (Condition C). When the weight thickness of the nickel-zinc-cobalt alloy layer is less than 30 mg/m², become an unstable adhesion state with a polyimide resin substrate is obtained. When the weight thickness of the nickel-zinc-cobalt alloy layer exceeds 70 mg/m², the alloy layer is too thick as the surface treatment layer to maintain good chemical resistance. As described above, the chemical resistance tends to increase as the surface treatment layer formed on the copper foil becomes as thin as possible. It is therefore more preferable that the nickel-zinc-cobalt alloy layer has a weight thickness within the range of 30 mg/m² to 40 mg/m². The chemical resistance is the most stable when the weight thickness of the nickel-zinc-cobalt alloy layer is within 40 mg/m².

(Type II)

The surface treated copper foil of type II has a surface treatment layer on the matte surface of the electro-deposited copper foil for improving the adhesion with a polyimide resin substrate. FIG. 3 shows a schematic sectional view of the surface treated copper foil 1b of type II. As is apparent from FIG. 3, an electro-deposited copper foil 2 for manufacturing the surface treated copper foil 1b of type II according to the present invention is used intentionally without applying roughening treatment to the matte surface. On the matte surface of the electro-deposited copper foil 2, a surface treatment layer 3 is provided. The surface on which the surface treatment layer 3 is provided is used as a bonding surface to the polyimide resin substrate. As the surface treatment layer, a nickel-zinc alloy layer, a cobalt-zinc alloy layer or a nickel-zinc-cobalt alloy layer is employed. To be more specifically, the difference between type II and type I resides in that the site on which a surface treatment layer is to be provided is either a matte surface or a shiny surface of the electro-deposited copper foil. However, since the matte surface initially has slight undulation compared to the shiny surface, it differs in laminate properties when the surface treatment layer is bonded to the polyimide resin substrate. Accordingly, type II is advantageous over type I since type II has higher peel strength. On the other hand, since the copper foil surface of type II in contact with a polyimide resin substrate has unduration, longer over-etching time must be given compared to type I, meaning that type II is disadvantageous in forming a fine-pitch circuit.

One of the surface treated copper foil belonging to type II is “a surface treated copper foil for a polyimide resin substrate characterized by being an electro-deposited copper foil having a surface treatment layer for improving adhesion with the polyimide resin substrate, in which the surface treatment layer is provided on a matte surface side of the electro-deposited copper foil and is a nickel-zinc alloy layer or a cobalt-zinc alloy layer containing nickel or cobalt in an amount of 65 wt % to 90 wt % and zinc in an amount of 10 wt % to 35 wt % except for inevitable impurities and having a weight thickness of 35 mg/m² to 120 mg/m²”. This is designated as “type IIa”.

Another type of surface treated copper foil belonging to type II is “a surface treated copper foil for a polyimide resin substrate characterized by being an electro-deposited copper foil having a surface treatment layer for improving adhesion with the polyimide resin substrate, in which the surface treatment layer is provided at the matte surface side of the electro-deposited copper foil and is a nickel-zinc-cobalt alloy layer satisfying the following conditions A to C”. Condition A is that “the total content of a cobalt content and a nickel content is 65 wt % to 90 wt % and a zinc content is 10 wt % to 35 wt % except for inevitable impurities”. Condition B is that “nickel is contained in the range of 1 wt % to 75 wt % and cobalt is contained in 15 wt % to 75 wt %”. Condition C is that “the weight thickness of the nickel-zinc-cobalt alloy layer is 35 mg/m² to 120 mg/m²”. This is designated as “type IIb”. The same reasons as mentioned in type Ib are adopted to the uppermost and lowermost values of these conditions.

It is not particularly necessary to define the thickness of the electro-deposited copper foil used in type II similarly to the case of type I. However, since type II, which has a surface treatment layer provided on the matte surface, is used as a bonding surface with a polyimide resin substrate, the matte surface of the electro-deposited copper foil is largely influenced by the thickness of the electro-deposited copper foil. Therefore, when a fine pitch circuit is formed using type II, a general electro-deposited copper foil having a thickness of 18 μm or less is preferably used. The lowermost value of the electro-deposited copper foil is not particularly defined; however, the lowermost value of the thickness may be 7 μm, which is a limit of the electro-deposited copper foil formed without using a carrier foil, as described above. Particularly when an electro-deposited copper foil is used for forming a fine pitch circuit, it is preferable to use a matte surface of a very low profile (VLP) copper foil having not more than 35 μm in thickness, which has an equivalent roughness to the shiny surface of a general electro-deposited copper foil.

It is presumed that the matte surface used herein has a roughness (Rzjis) of 1.0 μm or more. The electro-deposited copper foil recently developed tends to have a lower-profile matte surface. It is therefore possible to obtain a smooth matte surface equal to or lower than a shiny surface, which is a surface formed by mirror shape of an rotating drum thereto. Furthermore, in an electro-deposited copper foil, the shiny surface upon which copper starts to deposit and the matte surface obtained after deposit generally differ in crystalline orientation and grain size. In some cases, the matte surface is treated by a chemical means or the like on purpose to obtain a further smoother surface and put in use. Hence, in consideration of current market's demands, the roughness (Rzjis) is defined as 1.0 μm or more.

Surface Treatment Layer of Type IIa

The nickel-zinc alloy layer and the cobalt-zinc alloy layer to be used in type IIa as described above are basically considered in the same manner as in type Ia. Therefore, common explanation is omitted. Only difference is the thickness of the nickel-zinc alloy layer and the cobalt-zinc alloy layer.

In the case of the surface treated copper foil of type II, a surface treatment layer is formed not on the shiny surface as is in type I but on the matte surface. The specific surface areas of the shiny surface and the matte surface differ about 1.2 to 2.3 times. In order to form a surface treatment layer having the same thickness as is formed on the shiny surface, on a matte surface, the amount of deposition must be determined in consideration of the difference in specific surface area as a weight thickness. However, since the matte surface has a unevenness shape, there is a high possibility to cause current crowding at abnormal shape portions such as small projections when plating is performed for a long time or a high rate plating performed by using a large current, with the result that the uniformity in thickness of the plated deposition layer is impaired. Accordingly, the surface treatment layer must have a thickness effective in improving adhesion with a polyimide resin substrate and excellent in manufacturing stability.

In the case of type IIa, a weight thickness ranging from 35 mg/m² to 120 mg/m² is preferably employed. When a weight thickness of a nickel-zinc alloy layer or a cobalt-zinc alloy layer is less than 35 mg/m², basically good adhesion to a polyimide resin substrate cannot be obtained. When the weight thickness of the nickel-zinc alloy layer or the cobalt-zinc alloy layer exceeds 120 mg/m², the thickness of the surface treatment layer becomes nonuniform, with the result that good chemical resistance cannot be maintained. The chemical resistance tends to increase as the surface treatment layer formed on the copper foil becomes as thin as possible. Therefore, the nickel-zinc alloy layer or the cobalt-zinc alloy layer more preferably has a weight thickness within the range of 35 mg/m² to 85 mg/m². This is because the chemical resistance of the surface treatment layer is stable within the weight thickness of 85 mg/m².

Surface Treatment Layer of Type IIb

The nickel-zinc-cobalt alloy layer to be used in type IIb as described above is basically considered in the same manner as in type Ib. Therefore, common explanation is omitted. Only difference is the thickness of the nickel-zinc-cobalt alloy layer.

In the case of type IIb, similarly to the case of type IIa, a surface treatment layer is formed not on the shiny surface of type I but on the matte surface having a large specific surface area. Accordingly similarly to the case of type IIa, the thickness of the surface treatment layer to be employed must be set so as to improve the adhesion with a polyimide resin substrate and have excellent manufacturing stability in consideration of maintaining uniformity in film thickness of the plated layer to be deposited.

In the case of type IIb, it is preferable that the weight thickness of the nickel-zinc-cobalt alloy layer serving as a surface treatment layer falls within the range of 35 mg/m² to 120 mg/m². When the weight thickness of the nickel-zinc-cobalt alloy layer is less than 35 mg/m², basically good adhesion to a polyimide resin substrate cannot be obtained. When the weight thickness of the nickel-zinc-cobalt alloy layer exceeds 120 mg/m², an abnormal growth portion is observed in the surface treatment layer and the uniformity of the film thickness is impaired. As a result, good chemical resistance cannot be maintained. The chemical resistance, as described above, tends to increase as the surface treatment layer formed on the copper foil becomes as thin as possible. Therefore, it is more preferable that the weight thickness of the nickel-zinc-cobalt alloy layer falls within the range of 40 mg/m2 to 80 mg/m². This is because the chemical resistance of the nickel-zinc-cobalt alloy layer is the most stable within the weight thickness of 80 mg/m².

(Treatment Such as Rust Proofing of Surface Treated Copper Foil)

It is also preferable that each of the copper foils of type I and type II as described above has a chromate layer as a rust proofing layer on the surface of the surface treatment layer. Even if the chromate layer is provided, adhesion with a polyimide resin substrate can be maintained and long-term storageability of the surface treated copper foil can be ensured.

It is also preferable that a silane-coupling agent treatment layer is provided on the surface treatment layer serving as a bonding surface with a polyimide resin substrate or the chromate layer formed on the surface treatment layer. This is because use of the silane coupling agent can improve wettability between a metal and an organic material and the adhesion in bonding. The silane coupling agent layer is more preferably formed using an amino-base silane coupling agent or mercapto-base silane coupling agent. Among the silane coupling agents, these agents are most contributable to improving the adhesion between the copper foil layer and the polyimide resin substrate.

<Surface Treated Copper Foil Provided with a Carrier Foil According to the Present Invention>

In a surface treated copper foil 10 provided with a carrier foil according to the present invention, a bonding interface layer 7 is provided on the surface of a carrier foil 6; an electro-deposited copper foil layer 2 is provided on the bonding interface layer 7; and a surface treatment layer 3 is provided on the electro-deposited copper foil 2, as shown in FIG. 4.

(Carrier Foil)

Examples of a material to be used as the carrier foil include metal foils such as aluminum foil and copper foil and organic films having an electric conductivity. The reason why the electric conductivity is required resides in the manufacturing method described below. The thickness of the carrier foil is not particularly limited. The presence of the carrier foil makes it possible to extremely reduce the thickness of the electro-deposited copper foil layer 2 and is particularly useful in the case where the thickness of the carrier foil is 9 μm or less.

In particular, an electro-deposited copper foil is advantageously used as the carrier foil. The electro-deposited copper foil, which is usually manufactured through an electrolytic step and a surface treatment step, is principally used as a basic material for forming a printed wiring board that is used in the electric/electronic industry. The electro-deposited copper foil to be used as the carrier foil has preferably a thickness of 12 μm to 210 μm. The thickness of the electro-deposited copper foil to be used as a carrier foil is defined to fall in the range of 12 μm to 210 μm for the reasons below. For a carrier foil to serve as a reinforcing material for preventing wrinkle from generating in an extremely thin copper foil of 9 μm or less, the copper foil is required to have a thickness of at least about 12 μm; on the other hand, if the upper most thickness is 210 μm or more, the carrier may be not a copper foil but a copper strip, and becomes difficult to wind into a roll state.

(Bonding Interface Layer)

Surface treated copper foils provided with a carrier foil are divided into an etchable type, which requires removing of a carrier foil provided on the surface treated copper foil provided with the carrier foil by etching, and a peelable type, from which the carrier foil can be removed by peeling, depending upon the type of the bonding interface layer to be provided on the carrier foil. The present invention described herein includes both types.

The etchable type is manufactured by depositing a metal component such as zinc in a small amount to form a bonding interface layer, followed by forming a bulk copper layer on the bonding interface layer. In contrast, in the peelable type, the bonding interface layer is formed thick by use of a metal material such as zinc or chrome, or a metal oxide represented by chromate, or by use of an organic material.

Particularly in the case of the peelable type, the bonding interface layer is desirably formed of an organic material. This is because the peel strength can be stabilized at a low value when the carrier foil is peeled off. The organic material to be used herein is formed of one or two or more types of elements selected from the group consisting of a nitrogen-containing organic compound, a sulfur-containing organic compound and a carboxylic acid. Preferable examples of the nitrogen-containing organic compound include triazole compounds having a substituent, such as 1,2,3-benzotriazol and carboxybenzotriazole. Preferable examples of the sulfur containing organic compound include mercaptobenzothiazole, thiocyanuric acid and 2-benzimidazolthiol. As a carboxylic acid, particularly, a monocarboxylic acid is preferably used. Of them, oleic acid, linoleic acid and linolenic acid are preferably used.

(Electro-Deposited Copper Foil Layer and Surface Treatment Layer)

The thickness of the electro-deposited copper foil is not particularly limited; however, a thickness of 12 μm not more than is desirably employed. When the thickness is more than 12 μm, a merit of the surface treated copper foil provided with a carrier foil, that is, making handling of extremely thin copper foil easier, disappears. To tremendously improve the etching factor of a circuit formed by etching the electro-deposited copper foil layer, the thickness of the electro-deposited copper foil layer is preferably 5 μm or less and further preferably 3 μm or less. In practice, it is preferred to set the thickness within the range of 0.5 μm to 12 μm. The upper limit is defined for the reason that the thickness of 0.5 μm or more is required to obtain an electro-deposited copper foil layer uniform in thickness, as described above. If not, micro-porosities etc., are produced, failing to satisfy basic quality required for an electro-deposited copper foil. In addition, when type I and type II mentioned above are used distinctly in different application fields, the thickness of the electro-deposited copper foil layer should be less than 7 μm.

In the surface treated copper foil 10 provided with a carrier foil, since the bonding interface layer 7 positioned on the surface of the carrier foil 6 is used as an electrocrystallization surface for copper, the electro-deposited copper foil layer surface, on which a surface treatment layer 3 is to be formed, is a matte surface as is the same as in type II mentioned above. The same concept as adopted in type II concerning with the surface treatment layer seems to be directly adopted herein. However, the characteristic of the surface treated copper foil provided with a carrier foil resides in that the thickness of the electro-deposited copper foil can be set within the range of 0.5 μm to 7 μm. When the thickness of the electro-deposited copper foil reduces, the roughness of the matte surface comes closer to that of the shiny surface, with the result that both layers are not necessary to distinguish. Then, when the thickness of the electro-deposited copper foil layer is less than 7 μm, the same concept as adopted in type I concerning with the surface treatment layer is adopted herein. When the thickness of the electro-deposited copper foil layer is 7 μm or more, the same concept as adopted in type II is adopted.

Accordingly, the detailed description as to the surface treatment layer is omitted herein to avoid overlap description. When a nickel-zinc alloy layer or a cobalt-zinc alloy layer, is formed as the surface treatment layer on the surface of the electro-deposited copper foil layer, it is preferable that nickel or cobalt is contained in an amount of 65 wt % to 90 wt %, and zinc in an amount of 10 wt % to 35 wt % except for inevitable impurities and a weight thickness is set at 35 mg/m² to 70 mg/m². The upper limit and lower limit of these numerical values are defined for the same reasons as described in the case of the nickel-zinc alloy layer above. The upper limit of the weight thickness is set at 70 mg/m² in consideration of the fact that the electro-deposited copper foil layer (provided that the thickness of 12 μm or less is usually employed) used in the surface treated copper foil provided with a carrier foil has a smaller specific surface area than a general electro-deposited copper foil.

When a nickel-zinc-cobalt alloy layer is employed as the surface treatment layer, it must satisfy Condition A: “the total content of a cobalt content and a nickel content except for inevitable impurities is in the range of 65 wt % to 90 wt % and a zinc content is in the range of 10 wt % to 35 wt %”; Condition B: “nickel is contained in the range of 1 wt % to 75 wt % and cobalt is contained in the range of 15 wt % to 75 wt %”; and Condition C: “the weight thickness of the nickel-zinc-cobalt alloy layer is 35 mg/m² to 70 mg/m²”. The upper limit and lower limit of these numerical values are defined for the same reasons as described in the case of the nickel-zinc-cobalt alloy layer above. Note that the upper limit of a weight thickness is defined as 70 mg/m² for the same reasons as described above.

(Treatment Such as Rust Proofing of Surface Treated Copper Foil Provided with a Carrier Foil)

It is preferable that the surface treated copper foil provided with a carrier foil described above has a chromate layer as a rust proofing layer on the surface of the surface treatment layer. Furthermore, it also preferable that a silane coupling agent treatment layer is provided on the surface treatment layer serving as a bonding surface with a polyimide resin substrate and the chromate layer formed on the surface treatment layer. The concepts of the chromate layer and silane coupling agent are the same as described above and further explanation is omitted herein.

<Flexible Copper-Clad Laminate Using a Surface Treated Copper Foil or Surface Treated Copper Foil Provided with a Carrier Foil According to the Present Invention>

A surface treated copper foil as mentioned above is directly bonded to a polyimide resin substrate to form a flexible copper-clad laminate exhibiting good adhesion between the copper foil layer and the polyimide resin layer. When the copper-clad laminate is etched to form a circuit, and thereafter, even if tin is plated, no slip-in phenomenon of tin takes place at the interface between the circuit and polyimide resin substrate. As a result, a high-quality flexible printed wiring board can be obtained.

In the case of a surface treated copper foil provided with a carrier foil according to the present invention, the surface treated copper foil provided with a carrier foil is bonded to the polyimide resin substrate and then the carrier foil is removed to obtain a flexible copper-clad laminate exhibiting good adhesion between a copper foil layer and a polyimide resin layer. The thickness of the copper foil layer used herein may be set at 0.5 μm to 3 μm, which is suitable for forming an ultra-fine pitch circuit.

In particular, a surface treated copper foil or a surface treated copper foil provided with a carrier foil according to the present invention is slit in the form of tape and directly laminated onto a polyimide resin tape to form a tape film, which is most suitable for use in a film carrier tape for TAB.

### ADVANTAGES OF THE INVENTION

A surface treated copper foil or a surface treated copper foil provided with a carrier foil for a polyimide resin substrate according to the present invention has a surface treatment layer using a nickel-zinc alloy or a nickel-zinc-cobalt alloy on the bonding surface to the polyimide resin substrate. Therefore, it exhibits good adhesion to the polyimide resin substrate even if roughing treatment is not applied. As a result, a slip-in phenomenon of plated tin observed at the interface portion between the copper foil layer of a circuit portion obtained by etching and the polyimide resin substrate can be effectively prevented and thus a high-quality flexible printed wiring board can be obtained.

### BRIEF DESCRIPTION OF THE DRAWINGS

FIG. 1 is a schematic sectional view of a surface treated copper foil (type I) according to the present invention;

FIG. 2 is a schematic sectional view showing a slip-in phenomenon of plated tin;

FIG. 3 is a schematic sectional view of a surface treated copper foil (type II) according to the present invention; and

FIG. 4 is a schematic sectional view of a surface treated copper foil provided with a carrier foil according to the present invention.

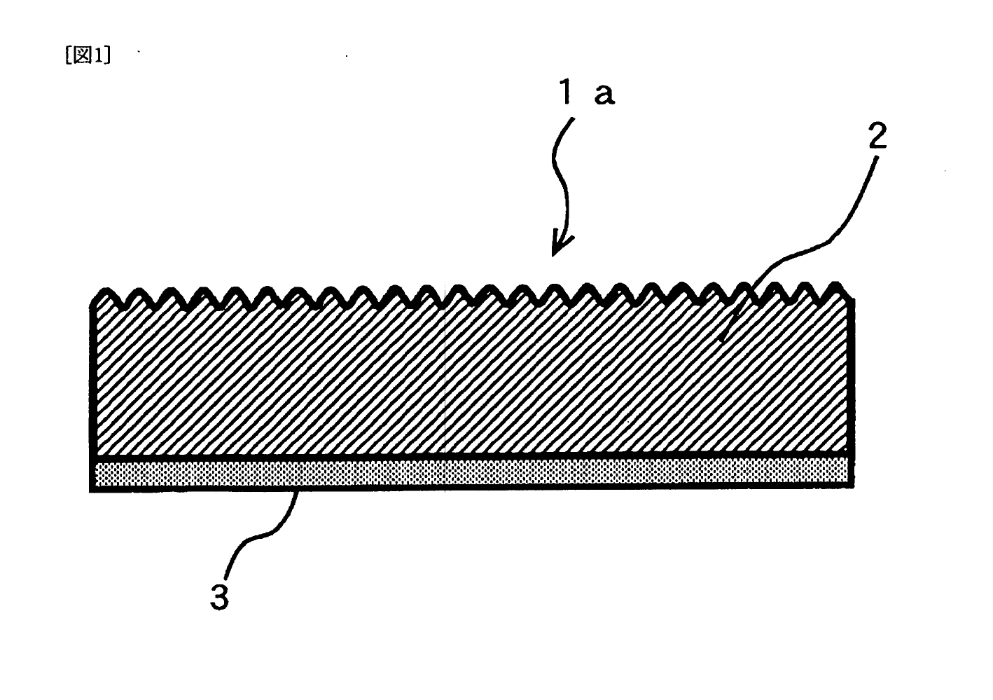

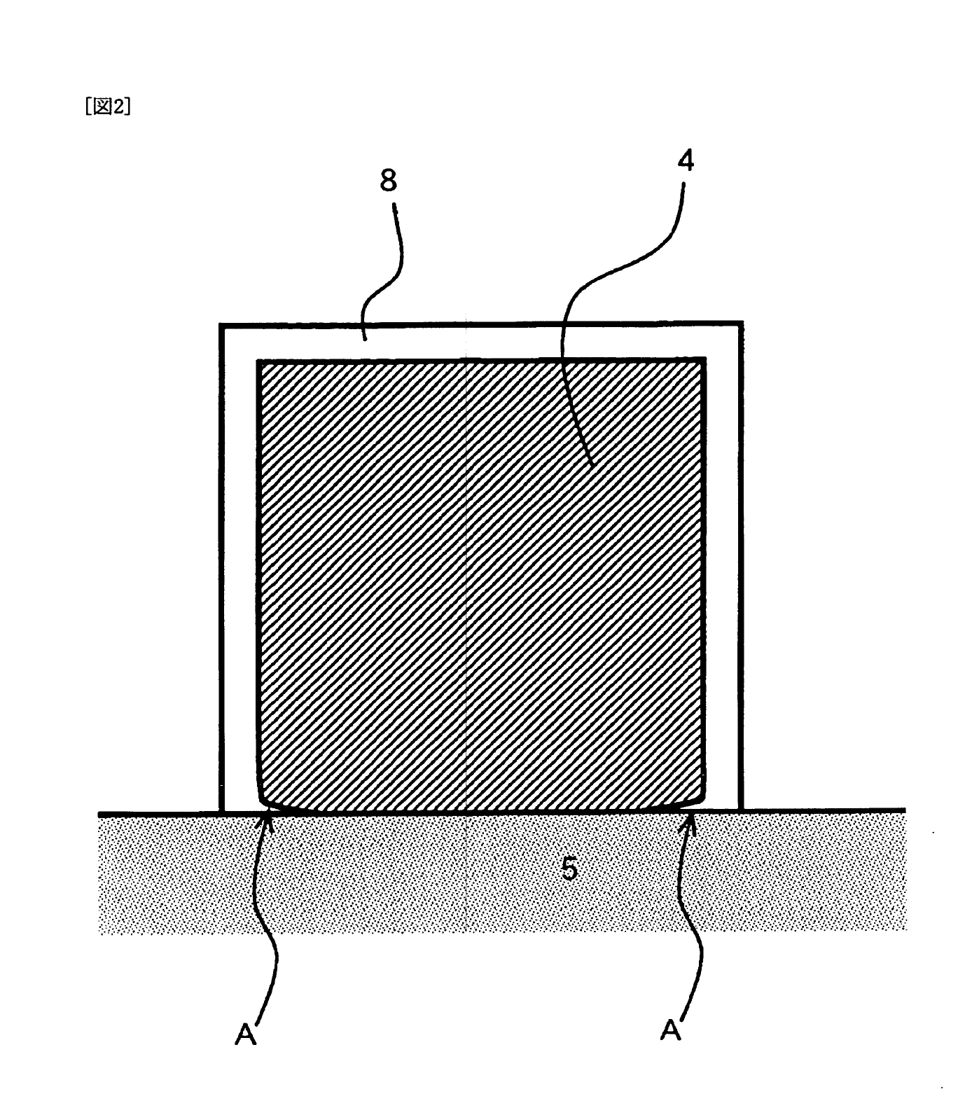

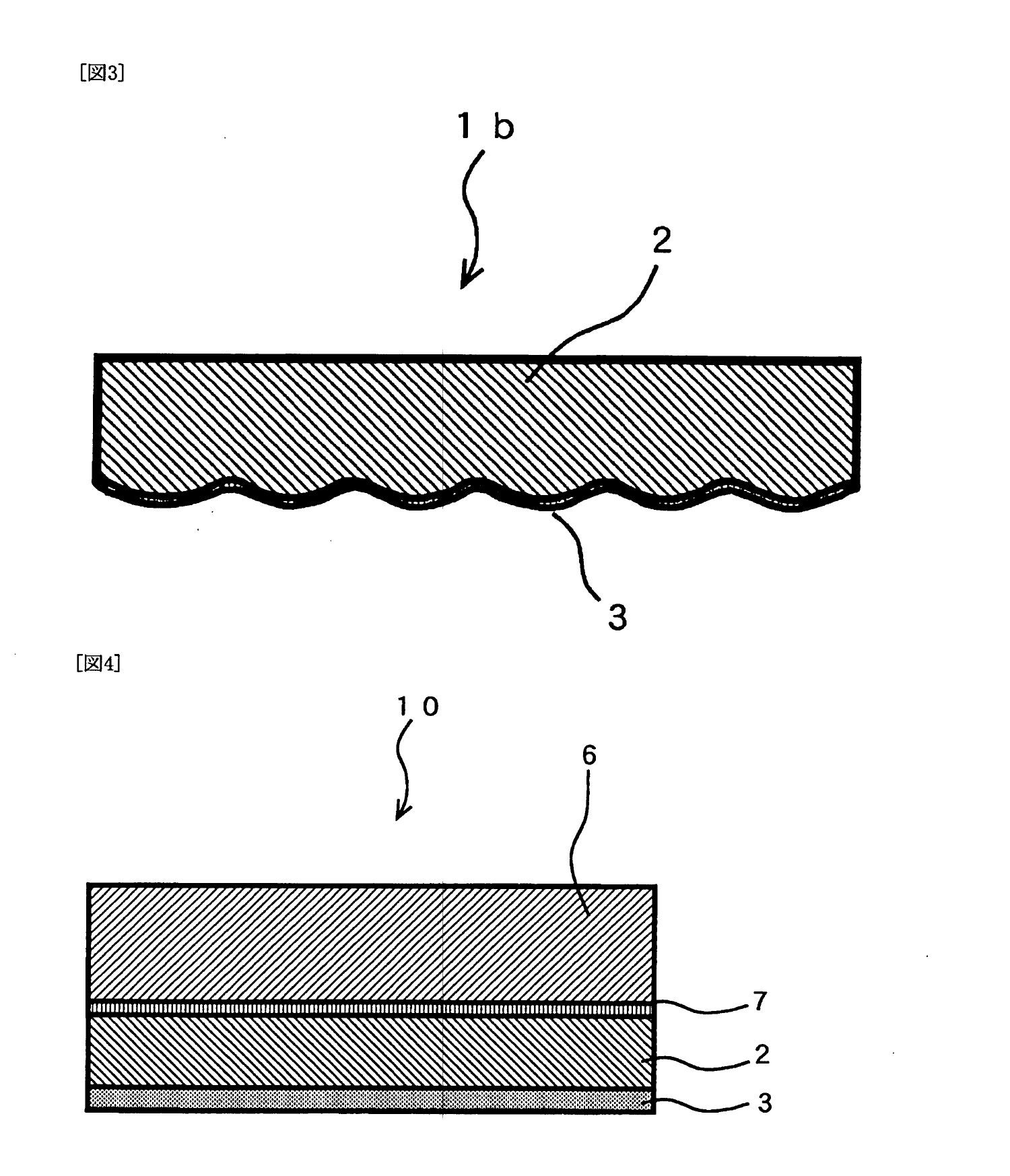

### DESCRIPTION OF SYMBOLS

1a, 1b Surface treated copper foil
2 Electro-deposited copper foil layer
3 Surface treatment layer
4 Circuit
5 Polyimide resin substrate
6 Carrier foil
7 Bonding interface layer
8 Tin plated layer
10 Surface treated copper foil provided with a carrier foil

### BEST MODE FOR CARRYING OUT THE INVENTION

<Embodiment for Manufacturing Surface Treated Copper Foil According to the Present Invention>

An electro-deposited copper foil itself can be manufactured satisfactorily by a conventional method. Therefore, the explanation of the method is omitted herein. Hence, a process for forming a surface treatment layer on the surface of the electro-deposited copper foil will be explained below.

(Cleaning of the Surface of Electro-Deposited Copper Foil)

The electro-deposited copper foil immediately after manufactured from a copper electrolytic solution such as a copper sulfate solution is in an activated state, and thus likely to bind to oxygen in the air to form an extra oxidative coating film. For this reason, it is preferred to apply cleaning treatment to the surface of the electro-deposited copper foil before the surface treatment layer is formed on the surface of the copper foil. This is because electro deposition is uniformly performed in the following formation step of the surface treatment layer. In the cleaning treatment, namely, pickling treatment, various types of solutions such as a hydrochloric pickling, a sulfuric acid solution and a sulfuric acid-hydrogen peroxide solution may be used. The solution to be used herein is not particularly limited to these. If necessary, degreasing treatment using an aqueous sodium hydroxide solution may be performed in combination before the pickling treatment. The concentration and temperature of these solutions can be controlled depending upon the characteristics of a production line.

(Formation of Surface Treatment Layer)

After completion of cleaning of the surface of an electro-deposited copper foil, a surface treatment layer of a nickel-zinc alloy composition or a nickel-zinc-cobalt alloy composition is formed on either the shiny surface or the matte surface of the electro-deposited copper foil in accordance with the method described below.

Surface Treatment Layer Formed of Nickel-Zinc Alloy

A nickel-zinc alloy layer is preferably formed by using, for example, nickel sulfate having a nickel concentration of 1 g/l to 2.5 g/l, zinc pyrophosphate having a zinc concentration of 0.1 g/l to 1 g/l, and potassium pyrophosphate of 50 g/l to 500 g/l under conditions: a solution temperature of 20 to 50° C., pH 8-11, and a current density of 0.3 to 10 A/dm². A nickel-zinc alloy layer having excellent uniformity in film thickness can be obtained by plating under these conditions. Outside these conditions, the content of nickel increases, producing residual ingredients after a circuit is formed and the ratio of zinc increases, with the result that chemical resistance and solder heat resistance are likely to decrease.

Surface Treatment Layer Formed of Cobalt-Zinc Alloy

A cobalt-zinc alloy layer is preferably formed by using, for example, cobalt sulfate having a cobalt concentration of 1 g/l to 2.0 g/l, a zinc pyrophosphate having a zinc concentration of 0.1 g/l to 1 g/l, and potassium pyrophosphate of 50 g/l to 500 g/l under conditions: a solution temperature of 20 to 50° C., pH 8-11, and a current density of 0.1 to 10 A/dm². A cobalt-zinc alloy layer having excellent uniformity in film thickness can be obtained by plating under these conditions. Outside these conditions, the content of cobalt increases, producing residual ingredients after a circuit is formed and the ratio of zinc increases, with the result that chemical resistance and solder heat resistance are likely to decrease.

Surface Treatment Layer Formed of Nickel-Zinc-Cobalt Alloy

A nickel-zinc-cobalt alloy layer is preferably formed by using cobalt sulfate of 50 g/l to 300 g/l, nickel sulfate of 50 to 300 g/l, a zinc sulfate of 50 to 300 g/l, and boric acid of 30 to 50 g/l, under conditions: a solution temperature of 45 to 55° C., pH 4-5, a current density of 1 to 10 A/dm². A nickel-zinc-cobalt alloy layer having excellent uniformity in film thickness can be obtained by plating under these conditions. Outside these conditions, a total content of nickel and cobalt increases, producing residual ingredients after a circuit is formed and the ratio of zinc increases, with the result that chemical resistance and solder heat resistance are likely to decrease.

(Formation of Chromate Layer)

When a chromate layer is formed on the surface treatment layer, either a substation method or an electrolytic method may be employed in accordance with a customary manner. The method is not particularly limited to these. The presence of chromate layer makes it possible to improve not only corrosion resistance but also adhesion with a polyimide resin layer.

(Silane Coupling Agent Treatment Layer)

Furthermore, it is preferable to provide a silane coupling agent treatment layer between the electro-deposited copper foil layer and the polyimide resin layer. The silane coupling agent treatment layer improves wettability with the surface of an electro-deposited copper foil to which roughening treatment is not applied and serves as an axillary agent for improving adhesion when the copper foil is press laminated onto a polyimide resin substrate. In view of this, as the silane coupling agent, use may be made of various types of silane coupling agents such as an epoxy functional silane coupling agent, olefin functional silane, and acrylic functional silane employed. Such a silane coupling agent contributes to improving the peel strength of the copper foil layer from the polyimide resin substrate. In this case, if an amino functional silane coupling agent or mercapto functional silane coupling agent is used herein, since the peel strength is particularly improved. The use of them is preferable.

The silane coupling agent treatment layer is formed by a method generally used such as a immersion method, showering method, and spray method. The method is not particularly limited to these. Any method may be used as long as it allows a solution containing a silane coupling agent to be in contact to a surface treatment layer most uniformly in accordance with step design to allow adsorption.

The silane coupling agent to be used herein will be described more specifically. Examples of the silane coupling agent include silane coupling agents principally for use in glass cloth treatment of a prepreg for a printed wiring board such as vinyltrimethoxysilane, vinylphenyltrimethoxysilane, γ-methacryloxypropyltrimethoxysilane, γ-glysidoxypropyltrimethoxysilane, 4-glycidylbutyltrimethoxysilane, γ-aminopropyltriethoxysilane, N-β(aminoethyl)γ-aminopropyltrimethoxysilane, N-3-(4-(3-(amino propoxy)butoxy)propyl-3-aminopropyltrimethoxysilane, imidazolesilane, triazinesilane, and γ-mercaptopropyltrimethoxysilane. When an amino silane coupling agent or a mercapto silane coupling agent is used, the effect of adhesion with a resin layer is significantly improved, compared to an epoxy functional silane coupling agent. More preferably, an amino functional silane coupling agent is favorably used which includes γ-aminopropyltriethoxysilane, N-β(aminoethyl)γ-aminopropyltrimethoxysilane, and N-3-(4-(3-aminopropoxy)butoxy)propyl-3-aminopropyltrimethoxysilane.

These silane coupling agents are used by dissolving each of them in water as a solvent in an amount of 0.5 to 10 g/l at about room temperature. The silane coupling agent binds to an OH group of the metal surface by condensation to form a silane coupling layer. The effect of the silane coupling agent is not significantly improved even if a solution containing a silane coupling agent in an unnecessarily excess concentration is used. The concentration thereof should be determined depending upon a treatment speed of the step, etc. However, when the concentration is less than 0.5 g/l, the adsorption rate of a silane coupling agent becomes low and thus unfavorable in view of general commercial-base profit. In addition, the adsorption becomes uneven. On the other hand, even if the concentration exceeds 10 g/l, the adsorption rate does not particularly go up and economically unfavorable.

The surface treatment layer is formed through the aforementioned steps to obtain a surface treated copper foil according to the present invention. Thereafter, on the surface of the surface treatment layer of the surface treated copper foil, a chromate treatment layer and a silane coupling agent treatment layer are formed as needed.

<Embodiment for Manufacturing a Surface Treated Copper Foil Provided with a Carrier Foil According to the Present Invention>

The surface treated copper foil provided with a carrier foil itself can be performed by a conventional method, explanation of which is intentionally omitted. An embodiment for forming a surface treatment layer on the surface of an electro-deposited copper foil layer is based on the same concept as used in forming a surface treatment layer of a nickel-zinc alloy composition or a nickel-zinc-cobalt alloy composition on a surface treated copper foil as mentioned above. Same applies to a chromate layer and a silane coupling agent treatment layer. To avoid overlap, explanation is omitted herein.

### EXAMPLE 1

In this example, the surface treated copper foil to type Ia was manufactured. As an electro-deposited copper foil, VLP copper foil of 18 μm in thickness manufactured by Mitsui Mining & Smelting Co., Ltd. was used.

(Cleaning Treatment of Electro-Deposited Copper Foil)

The surface of the electro-deposited copper foil was subjected to a pickling treatment with acid solution to completely remove oily components attached, and remove an extra oxide layer of the surface. The pickling treatment was performed by immersion the foil in a diluted sulfur solution having a concentration of 100 g/l and a solution temperature of 30° C., for immersion time of 30 seconds, followed by rinsing the foil with water. The oily components attached and extra surface oxide coating film were removed from the surface by the pickling treatment.

(Formation of Surface Treatment Layer)

Surface treatment was herein applied to two types of surface treatment layers of a nickel-zinc alloy layer and a cobalt-zinc alloy layer. More specifically, to form a nickel-zinc alloy layer on the shiny surface (Rzjis=0.98 μm) of a first electro-deposited copper foil, a plating solution composition was prepared using nickel sulfate, zinc pyrophosphate and potassium pyrophosphate, and electrolyzed under the conditions of a solution temperature of 40° C. As a result, a nickel-zinc alloy plated layer containing 71 wt % of nickel and 29 wt % of zinc and having a weight thickness of 41.8 mg/m² was formed and then rinsed with water. The same conditions were employed below when a nickel-zinc alloy was plated.

To form a cobalt-zinc alloy layer on a second electro-deposited copper foil (the same as a first electro-deposited copper foil), a plating solution composition was prepared using cobalt sulfate, zinc pyrophosphate and potassium pyrophosphate, and electrolyzed subjected to electrolysis under the conditions of a solution temperature of 40° C. As a result, a cobalt-zinc alloy plated layer containing 45 wt % of cobalt and 55 wt % of zinc and having a weight thickness of 65.4 mg/m² was formed and then rinsed with water. The same conditions were employed below when a cobalt-zinc alloy was plated.

(Formation of Chromate Layer)

After formation of the surface treatment layer was completed, a chromate treatment layer was formed on the surface treatment layer. The chromate treatment was electrolytically performed to form a chromate layer on a nickel-zinc alloy plated layer or a cobalt-zinc alloy plated layer. The electrolysis was performed herein under the conditions including chromic acid: 1.0 g/l, a solution temperature: 35° C., a current density: 8 A/dm² and electrolytic time: 5 seconds. The same conditions were used below when a chromate layer was formed.

(Formation of Silane Coupling Agent Treatment Layer)

A silane coupling agent treatment layer was formed herein on the chromate treatment layer. The silane coupling agent treatment layer was formed by preparing a solution in such a manner that γ-aminopropyltrimethoxysilane was added to ion exchanged water as a solvent in concentration of 5 g/l, and spraying the solution like shower onto the surface of the chromate layer, thereby performing adsorption treatment, and maintaining the resultant layer in a dehydration furnace of an atmosphere in which the foil was kept at reached 150° C. for 4 seconds, thereby removing a moisture content to accelerate a condensation reaction of the silane coupling agent. The same conditions were employed below when silane coupling agent treatment was performed. Through the steps mentioned above, the surface treated copper foil of type Ia was obtained. The surface treated copper foil having a nickel-zinc alloy layer formed thereon will be called as a first surface treated copper foil, and the surface treated copper foil having a cobalt-zinc alloy layer formed thereon will be called as a second surface treated copper foil.

(Formation of Flexible Copper-Clad Laminate)

On the surface treatment layers of the first surface treated copper foil and the second surface treated copper foil, polyimide resin substrate layers were formed by a well-known casting method to obtain flexible copper-clad laminates.

(Performance Evaluation Results)

On the copper foil surface of each of the flexible copper-clad laminates, an etching resist layer was formed. An etching pattern was formed by light exposure and developed, and thereafter, etching of a circuit was performed. The etching resist was removed to obtain a test flexible printed wiring board having a linear circuit of 0.2 mm in width for measuring peel strength. Subsequently, the peel strength was measured using the linear circuit. As a result, the first surface treated copper foil had a peel strength of 1.87 kgf/cm as received state and a peel loss ratio after dipping hydrochloric-acid solution of 2.3%; whereas the second surface treated copper foil had a peel strength of 1.94 kgf/cm as received state and a peel loss ratio after dipping hydrochloric-acid solution of 3.0%. Both exhibited good adhesion to a polyimide resin substrate. Note that the peel loss ratio after dipping hydrochloric-acid solution was obtained as follows. The 0.2 mm-wide circuit of the test flexible printed wiring board was immersed in a solution containing hydrochloric acid and water in a ratio of 1:1 for one hour at room temperature, picked up from the solution, and rinsed with water. Immediately after dry, the peel strength was measured. The peel strength was evaluated as to peel loss ratio (%) compared to the peel strength as received state; more specifically calculated in accordance with the following equation:
Peel loss ratio after dipping hydrochloric-acid solution=(peel strength as received state)−(peel strength after hydrochloric acid dipping)/(peel strength as received state)

Note that the peel strength was measured when it was peeled at an angle of 180°. The same conditions were used in the following Examples and Comparative Examples.

Furthermore, tin was plated onto the linear circuit for measuring the peel strength of the test flexible printed wring board to evaluate degree of slip-in of plated tin. Tin was plated by subjecting stannous sulfate containing tin in a concentration of 20 g/l, to electrolysis under conditions: solution temperature 30° C., pH:3, and current density: 5 A/dm² to obtain a tin layer of 2 μm in thickness. The degree of slip-in of plated tin was evaluated by peeling the circuit after tin plating and observing a side edge portion of the surface of the circuit after peeling by an optical microscope, and judged based on whether deposition of the plated tin was observed or not. As a result, slip-in of plated tin was not substantially observed either in the case of using the first surface treated copper foil or in the case of using the second surface treated copper foil.

### EXAMPLE 2

In this example, a surface treated copper foil of type Ib was manufactured in the same conditions as in Example 1 except for a method of forming a surface treatment layer. That is, the cleaning treatment of an electro-deposited copper foil, formation of a chromate layer, formation of a silane coupling agent treatment layer, manufacturing of a flexible copper-clad laminate, and manufacturing for a test flexible printed wiring board were made in common manners. Accordingly, formation of a surface treatment layer and evaluation results alone will be explained.

(Formation of Surface Treatment Layer)

To form a nickel-zinc-cobalt alloy layer on the shiny surface (Rzjis=0.98 μm) of an electro-deposited copper foil as a surface treatment layer, a plating solution composition was prepared using cobalt sulfate, nickel sulfate, zinc sulfate, and boric acid, subjected to electrolysis under the conditions of a solution temperature of 50° C., a pH of 4.5, and a current density of 8 A/dm². Five types of nickel-zinc-cobalt alloy plated layers different in composition of nickel, zinc and cobalt and weight thickness were formed as a surface treatment layer and rinsed with water. Thereafter, 5 types of surface treated copper foils were obtained in the same manner as in Example 1 and will be referred to as “2-1”, “2-2”, “2-3”, and “2-4” and “2-5”.

(Performance Evaluation Results)

Using each of the surface treated copper foils mentioned above, a test flexible printed wring board having a linear circuit of 0.2 mm in width was formed for measuring peel strength. Using the liner circuit, peel strength as received state and the Peel loss ratio after dipping hydrochloric-acid solution were obtained in the case where each surface treated copper foil was used. Besides this, degree of slip-in of plated tin was evaluated in the same manner as in Example 1. The evaluation results are summarized in Table 1.

TABLE 1

| | Weight/ | | | | | | | |
|---|---|---|---|---|---|---|---|---|
| | thickness | Content (wt %) | | | | P/S* | | Slip-in |
| Sample | mg/m² | Zn | Ni | Co | Ni + Co | kgf/cm | Peel loss ratio** % | evaluation*** |
| 2-1 | 61.3 | 13 | 69 | 18 | 87 | 2.45 | 1.2 | Not observed |
| 2-2 | 53.0 | 17 | 11 | 72 | 83 | 2.47 | 4.7 | Not observed |
| 2-3 | 69.4 | 10 | 33 | 57 | 90 | 2.35 | 0.0 | Not observed |
| 2-4 | 45.0 | 35 | 40 | 25 | 65 | 2.40 | 1.1 | Not observed |
| 2-5 | 35.0 | 24 | 41 | 35 | 76 | 2.40 | 2.0 | Not observed |

*P/S: Peel strength as received state
**Peel loss ratio: Peel loss ratio after dipping hydrochloric-acid solution
***Slip-in evaluation: Evaluation of degree of slip-in of plated tin

### EXAMPLE 3

In this example, a surface treated copper foil of type IIa was manufactured in the same conditions as in Example 1 except that the arrangement of the surface treatment layer is different. That is, the cleaning treatment of an electro-deposited copper foil, formation of a chromate layer, formation of a silane coupling agent treatment layer, manufacturing of a flexible copper-clad laminate, and manufacturing for a test flexible printed wiring board were made in common manners. Accordingly, formation of a surface treatment layer and evaluation results alone will be explained.

(Formation of Surface Treatment Layer)

The same nickel-zinc plating solution as in Example 1 was used to form a nickel-zinc alloy plated layer containing 71 wt % of nickel and 29 wt % of zinc and having a weight thickness of 80.3 mg/m² as a surface treatment layer on the matte surface (Rzjis=2.5 μm) of the electro-deposited copper foil and rinsed with water, on one hand. On the other hand, the same cobalt-zinc alloy plating solution as in Example 1 was used to form a cobalt-zinc alloy plated layer containing 45 wt % of cobalt and 55 wt % of zinc and having a weight thickness of 65.4 mg/m² and rinsed with water. The surface treatment layers were formed as described above and the same treatments as in Example 1 were applied to obtain a first surface treated copper foil and a second surface treated copper foil.

(Performance Evaluation Results)

A test flexible printed wiring board having a linear circuit of 0.2 mm in width for measuring peel strength was obtained using the first surface treated copper foil and the second surface treated copper foil in the same manner as in Example 1. Then, using the liner circuit, the peel strength was measured. As a result, the peel strength of the first surface treated copper foil as received state was 1.88 kgf/cm and a peel loss ratio after dipping hydrochloric-acid solution was 3.5%, whereas the peel strength of the second surface treated copper foil as received state was 1.98 kgf/cm and a peel loss ratio after dipping hydrochloric-acid solution was 2.8%. Good adhesion to a polyimide resin substrate was exhibited. Furthermore, degree of slip-in of plated tin was evaluated in the same manner as in Example 1. As a result, substantial slip-in was observed in neither in the first surface treated copper foil nor the second surface treated copper foil.

### EXAMPLE 4

In this example, a surface treated copper foil of type IIb was manufactured in the same conditions as in Example 2 except that the arrangement of the surface treatment layer is different. That is, the cleaning treatment of an electro-deposited copper foil, formation of a chromate layer, formation of a silane coupling agent treatment layer, manufacturing of a flexible copper-clad laminate, and manufacturing for a test flexible printed wiring board were made in common manners. Accordingly, formation of a surface treatment layer and evaluation results alone will be explained.

(Formation of Surface Treatment Layer)

To form a nickel-zinc-cobalt alloy layer on the matte surface (Rzjis=2.5 μm) of an electro-deposited copper foil as a surface treatment layer, a plating solution composition was prepared using cobalt sulfate, nickel sulfate, zinc sulfate, and boric acid, subjected to electrolysis under the conditions of a solution temperature of 50° C., a pH of 4.5, and a current density of 8 A/dm². As a result, a nickel-zinc-cobalt alloy plated layer containing 9 wt % of nickel, 55 wt % of zinc and 18 wt % of cobalt and having a weight thickness of 65.4 mg/m² was formed and then rinsed with water. Five types of surface treated copper foils were obtained in the same manner as in Example 1, below. These 5 types of surface treated copper foils will be referred to as “4-1”, “4-2”, “4-3”, “4-4” and “4-5”.

(Performance Evaluation Results)

Using each of the surface treated copper foils mentioned above, a test flexible printed wring board having a linear circuit of 0.2 mm in width for measuring peel strength was formed in the same manner as in Example 1. Then, using the liner circuit, peel strength as received state and peel loss ratio after dipping hydrochloric-acid solution were obtained in the case of using each surface treated copper foil, and furthermore degree of slip-in of plated tin was evaluated in the same manner as in Example 1. The evaluation results are summarized in Table 2.

TABLE 2

| | Weight/ | | | | | | | |
|---|---|---|---|---|---|---|---|---|
| | thickness | Content (wt %) | | | | P/S* | | Slip-in |
| Sample | mg/m² | Zn | Ni | Co | Ni + Co | kgf/cm | Peel loss ratio** % | evaluation*** |
| 4-1 | 120.0 | 10 | 43 | 47 | 90 | 2.48 | 2.4 | Not observed |
| 4-2 | 90.3 | 17 | 11 | 72 | 83 | 2.51 | 3.5 | Not observed |
| 4-3 | 69.8 | 15 | 30 | 55 | 85 | 2.53 | 2.8 | Not observed |
| 4-4 | 47.5 | 35 | 40 | 25 | 65 | 2.51 | 2.5 | Not observed |
| 4-5 | 35.0 | 25 | 40 | 35 | 76 | 2.49 | 3.1 | Not observed |

*P/S: Peel strength as received state
**Peel loss ratio: Peel loss ratio after dipping hydrochloric-acid solution
***Slip-in evaluation: Evaluation of degree of slip-in of plated tin

### EXAMPLE 5

In this example, an electro-deposited copper foil of 35 μm in thickness was used as a carrier foil and a bonding interface layer formed of chromium oxide was provided on the shiny surface of the carrier foil. On the bonding interface layer, an electro-deposited copper foil of 3 μm in thickness was provided by electrolysis of a copper sulfate solution. The electro-deposited copper foil provided with a carrier foil formed in this manner was used. The roughness (Rzjis) of the electro-deposited copper foil layer was 1.0 μm.

(Formation of Surface Treatment Layer)

On the electro-deposited copper foil surface of the electro-deposited copper foil provided with a carrier foil, a nickel-zinc alloy plated layer containing 71 wt % of nickel, 29 wt % of zinc and having a weight thickness of 50.2 mg/m² was formed by using the same nickel-zinc plating solution as in Example 1. Thereafter, through the same process as in Example 1, a first surface treated copper foil provided with a carrier foil was obtained. Furthermore, a cobalt-zinc alloy plated layer containing 45 wt % of cobalt and 55 wt % of zinc and having a weight thickness of 45.4 mg/m² was formed by using the same cobalt-zinc plating solution as in Example 1. Thereafter, through the same process as in Example 1, a second surface treated copper foil provided with a carrier foil was obtained.

(Performance Evaluation Results)

Using the first surface treated copper foil provided with a carrier foil and the second surface treated copper foil provided with a carrier foil, press lamination was performed in the same manner as in Example 1. After the carrier foil was removed, a copper sulfur solution was electrolyzed to plate a copper foil layer of a flexible copper-clad laminate up to 18 μm in thickness. Etching process was performed to obtain a test flexible printed wring board having a linear circuit of 0.2 mm in width for measuring peel strength. When peel strength was measured using the linear circuit, the peel strength of the first surface treated copper foil provided with a carrier foil was 1.81 kgf/cm as received state and the peel loss ratio after dipping hydrochloric-acid solution thereof was 3.0%, whereas the peel strength of the second surface treated copper foil provided with a carrier foil was 1.87 kgf/cm as received state and the peel loss ratio after dipping hydrochloric-acid solution thereof was 3.1%. Good adhesion to a polyimide resin substrate was exhibited. In both cases where the first surface treated copper foil provided with a carrier foil and the second surface treated copper foil provided with a carrier foil were used, the degree of slip-in of tin plate was checked in the same manner as in Example 1. Slip-in of the plated tin was not significantly observed.

### EXAMPLE 6

In this example, the same electro-deposited copper foil of 35 μm in thickness as used in Example 5 was used as carrier foil. On the shiny surface thereof, the bonding interface layer of chromium oxide was provided. On the bonding interface layer, an electro-deposited copper foil of 3 μm in thickness was provided by electrolysis of a copper sulfate solution. The electro-deposited copper foil provided with a carrier foil formed in this manner was used.

(Formation of Surface Treatment Layer)

On the electro-deposited copper foil surface of the electro-deposited copper foil provided with a carrier foil, a nickel-zinc-cobalt alloy plated layer containing 33 wt % of nickel, 10 wt % of zinc, and 57 wt % of cobalt and having a weight thickness of 45.0 mg/m² was formed by using the same nickel-zinc-cobalt plating solution as in Example 2. Thereafter, through the same process as in Example 1, 5 types of surface treated copper foils provided with a carrier foil was obtained. These 5 types of surface treated copper foils will be referred to as “6-1”, “6-2”, “6-3”, and “6-4”.

(Performance Evaluation Results)

Using each of the surface treated copper foils provided with a carrier foil, press lamination was performed in the same manner as in Example 1. After the carrier foil was removed, a copper sulfur solution was electrolyzed to plate a copper foil layer of a flexible copper-clad laminate up to 18 μm. Etching process was performed to obtain a test flexible printed wring board having a linear circuit of 0.2 mm in width for measuring peel strength. When peel strength was measured using the linear circuit, the peel strength of each of the surface treated copper foils provided with a carrier foil as received state and the peel loss ratio after dipping hydrochloric-acid solution thereof were obtained. Furthermore, the degree of slip-in of plated tin was evaluated in the same manner as in Example 1. The evaluation results are summarized in Table 3.

TABLE 3

| | Weight/ | | | | | | | |
|---|---|---|---|---|---|---|---|---|
| | thickness | Content (wt %) | | | | P/S* | | Slip-in |
| Sample | mg/m² | Zn | Ni | Co | Ni + Co | kgf/cm | Peel loss ratio** % | evaluation*** |
| 6-1 | 70.0 | 10 | 40 | 50 | 90 | 2.13 | 1.4 | Not observed |
| 6-2 | 50.5 | 15 | 18 | 68 | 86 | 2.15 | 1.5 | Not observed |
| 6-3 | 43.4 | 25 | 30 | 45 | 75 | 2.10 | 0.0 | Not observed |
| 6-4 | 35.0 | 35 | 40 | 25 | 65 | 2.15 | 1.5 | Not observed |

*P/S: Peel strength as received state
**Peel loss ratio: Peel loss ratio after dipping hydrochloric-acid solution
***Slip-in evaluation: Evaluation of degree of slip-in of plated tin

### COMPARATIVE EXAMPLE

In this Comparative Example, a surface treated copper foil having a nickel-zinc alloy layer rich in zinc content was manufactured as a surface treatment layer of Example 1 and performance evaluation was performed in the same manner as Examples mentioned above. The cleaning treatment of an electro-deposited copper foil, formation of a chromate layer, formation of a silane coupling agent treatment layer, manufacturing of a flexible copper-clad laminate, and manufacturing for a test flexible printed wiring board were made in common manners. Accordingly, formation of a surface treatment layer and evaluation results alone will be explained.

(Formation of Surface Treatment Layer)

In this Comparative Example, to form a nickel-zinc alloy layer rich in zinc content on the shiny surface (Rzjis=0.98 μm) of an electro-deposited copper foil as a surface treatment layer, electrolysis was performed using nickel sulfate containing nickel in a concentration of 0.1 g/l, zinc pyrophosphate containing zinc in a concentration of 5.4 g/l and 100 g/l of potassium pyrophosphate, under conditions: a solution temperature of 40° C. to form a zinc-nickel alloy plated layer containing 46 wt % of nickel and 54 wt % of zinc and having a weight thickness of 42.3 mg/m², and rinsed with water.

(Performance Evaluation Results)

A test flexible printed wring board having a linear circuit of 0.2 mm in width for measuring peel strength was formed in the same manner as in Example 1. When peel strength was measured using the linear circuit, the peel strength as received state was 1.65 kgf/cm and the peel loss ratio after dipping hydrochloric-acid solution was 12.3%. In the evaluation of comparative Example, Peel strength as received state showed a low level and Peel loss ratio after dipping hydrochloric-acid solution was higher than those of Examples mentioned above. Degree of slip-in of plated tin was evaluated in the same manner as in Example 1. Plated tin was confirmed to slip in by about 2 μm from the circuit edge.

### INDUSTRIAL APPLICABILITY

A surface treated copper foil and a surface treated copper foil provided with a carrier foil according to the present invention do not require to perform a roughening treatment onto the contact face with a polyimide resin substrate. It is therefore possible to omit a manufacturing step and reduce manufacturing cost. Furthermore, even though the roughening treatment of an electro-deposited copper foil is omitted, a sufficient peel strength to be used as a practical flexible printed wiring board can be obtained. Besides this, no slip-in phenomenon of plated tin occurs during tin plating. As a result, the adhesion stability to the polyimide resin substrate becomes excellent. Moreover, since roughening treatment is not applied to the copper foil layer, over-etching time is not required even in a circuit etching. As a result, processing cost can be drastically reduced; at the same time, a circuit whose pitch is further finer than 50 μm can be suitably formed.

1. A surface treated copper foil for a polyimide resin substrate, which is an electro-deposited copper foil having a surface treatment layer for improving adhesion to a polyimide resin substrate,
wherein the surface treatment layer is provided on a shiny surface side of the electro-deposited copper foil and is a nickel-zinc alloy layer or a cobalt-zinc alloy layer containing nickel or cobalt in an amount of 65 wt % to 90 wt % and zinc in an amount of 10 wt % to 35 wt % except for inevitable impurities and having a weight thickness of 30 mg/m² to 70 mg/m².

2. The surface treated copper foil for a polyimide resin substrate according to claim 1, wherein the shiny surface has a roughness (Rzjis) of 2.0 μm or less.

3. The surface treated copper foil according to claim 1, wherein the surface having the surface treatment layer has a glossiness [Gs(60°)] of 180% or less.

4. The surface treated copper foil for a polyimide resin substrate according to claim 1, wherein a silane coupling agent treatment layer is provided at an outermost layer of a bonding surface of the electro-deposited copper foil in contact with the polyimide resin substrate.

5. The surface treated copper foil for a polyimide resin substrate according to claim 4, wherein the silane coupling agent treatment layer is formed of an amino silane coupling agent or a mercapto silane coupling agent.

6. A surface treated copper foil for a polyimide resin substrate, which is an electro-deposited copper foil having a surface treatment layer for improving adhesion to a polyimide resin substrate at a shiny surface side,
wherein the surface treatment layer is provided at the shiny surface side of the electro-deposited copper foil and is a nickel-zinc-cobalt alloy layer satisfying the following conditions A to C,
A: the total content of a cobalt content and a nickel content is 65 wt % to 90 wt % and a zinc content is 10 wt % to 35 wt % except for inevitable impurities;
B: nickel is contained in the range of 10 wt % to 70 wt % and cobalt is contained in the range of 18 wt % to 72 wt %; and
C: a weight thickness of the nickel-zinc-cobalt alloy layer is 30 mg/m² to 70 mg/m².

7. The surface treated copper foil for a polyimide resin substrate according to claim 6, wherein the shiny surface has a roughness (Rzjis) of 2.0 μm or less.

8. The surface treated copper foil according to claim 6, wherein the surface having the surface treatment layer has a glossiness [Gs(60°)] of 180% or less.

9. The surface treated copper foil for a polyimide resin substrate according to claim 6, wherein a silane coupling agent treatment layer is provided at an outermost layer of a bonding surface of the electro-deposited copper foil in contact with the polyimide resin substrate.

10. The surface treated copper foil for a polyimide resin substrate according to claim 6, wherein the silane coupling agent treatment layer is formed of an amino silane coupling agent or a mercapto silane coupling agent.

11. A surface treated copper foil for a polyimide resin substrate, which is an electro-deposited copper foil having a surface treatment layer for improving adhesion to a polyimide resin substrate,
wherein the surface treatment layer is provided on a matte surface side of the electro-deposited copper foil and is a nickel-zinc alloy layer or a cobalt-zinc alloy layer containing nickel or cobalt in an amount of 65 wt % to 90 wt % and zinc in an amount of 10 wt % to 35 wt % except for inevitable impurities and having a weight thickness of 35 mg/m² to 120 mg/m².

12. The surface treated copper foil for a polyimide resin substrate according to claim 11, wherein the matte surface has a roughness (Rzjis) exceeding 1.0 μm.

13. The surface treated copper foil for a polyimide resin substrate according to claim 11, wherein a chromate layer is provided on a surface of the surface treatment layer as a rust proofing layer.

14. The surface treated copper foil for a polyimide resin substrate according to claim 11, wherein a silane coupling agent treatment layer is provided at an outermost layer of a bonding surface of the electro-deposited copper foil in contact with the polyimide resin substrate.

15. The surface treated copper foil for a polyimide resin substrate according to claim 14, wherein the silane coupling agent treatment layer is formed of an amino silane coupling agent or a mercapto silane coupling agent.

16. A surface treated copper foil for a polyimide resin substrate, which is an electro-deposited copper foil having a surface treatment layer for improving adhesion to a polyimide resin substrate,
wherein the surface treatment layer is provided at the matte surface side of the electro-deposited copper foil and is a nickel-zinc-cobalt alloy layer satisfying the following conditions A to C,
A: the total content of a cobalt content and a nickel content is 65 wt % to 90 wt % and a zinc content is 10 wt % to 35 wt % except for inevitable impurities;
B: nickel is contained in the range of 10 wt % to 70 wt % and cobalt is contained in 18 wt % to 72 wt %; and
C: a weight thickness of the nickel-zinc-cobalt alloy layer is 35 mg/m² to 120 mg/m².

17. The surface treated copper foil for a polyimide resin substrate according to claim 16, wherein the matte surface has a roughness (Rzjis) exceeding 1.0 μm.

18. The surface treated copper foil for a polyimide resin substrate according to claim 16, wherein a chromate layer is provided on a surface of the surface treatment layer as a rust proofing layer.

19. The surface treated copper foil for a polyimide resin substrate according to claim 16, wherein a silane coupling agent treatment layer is provided at an outermost layer of a bonding surface of the electro-deposited copper foil in contact with the polyimide resin substrate.

20. The surface treated copper foil for a polyimide resin substrate according to claim 16, wherein the silane coupling agent treatment layer is formed of an amino silane coupling agent or a mercapto silane coupling agent.

21. A surface treated copper foil provided with a carrier foil for a polyimide resin substrate, which is an electro-deposited copper foil provided with a carrier foil having a surface treatment layer for improving adhesion to a polyimide resin substrate,
wherein the electro-deposited copper foil provided with a carrier foil is formed by successively laminating a carrier foil layer, a bonding interface layer and an electro-deposited copper foil layer; on the surface of the electro-deposited copper foil layer, the surface treatment layer is provided, which is characterized by being a nickel-zinc alloy layer or a cobalt-zinc alloy layer containing nickel or cobalt in an amount of 65 wt % to 90 wt % and zinc in an amount of 10 wt % to 35 wt % except for inevitable impurities, and having a weight thickness of 35 mg/m² to 70 mg/m².

22. The surface treated copper foil provided with a carrier foil for a polyimide resin substrate according to claim 21, wherein a chromate layer is provided on a surface of the surface treatment layer as a rust proofing layer.

23. The surface treated copper foil provided with a carrier foil for a polyimide resin substrate according to claim 21, wherein a silane coupling agent treatment layer is provided at an outermost layer of a bonding surface of the electro-deposited copper foil in contact with the polyimide resin substrate.

24. The surface treated copper foil provided with a carrier foil for a polyimide resin substrate according to claim 23, wherein the silane coupling agent treatment layer is formed of an amino silane coupling agent or a mercapto silane coupling agent.

25. A surface treated copper foil provided with a carrier foil for a polyimide resin substrate, which is an electro-deposited copper foil provided with a carrier foil having a surface treatment layer for improving adhesion to a polyimide resin substrate,
wherein the electro-deposited copper foil provided with a carrier foil is formed by successively laminating a carrier foil layer, a bonding interface layer and an electro-deposited copper foil layer; and a nickel-zinc-cobalt alloy layer satisfying the following conditions A to C is provided as the surface treatment layer on the surface of the electro-deposited copper foil layer,
A: the total content of a cobalt content and a nickel content is 65 wt % to 90 wt % and a zinc content is 10 wt % to 35 wt % except for inevitable impurities;
B: nickel is contained in the range of 10 wt % to 70 wt % and cobalt is contained in the range of 18 wt % to 72 wt %; and
C: a weight thickness of the nickel-zinc-cobalt alloy layer is 35 mg/m² to 70 mg/m².

26. The surface treated copper foil provided with a carrier foil for a polyimide resin substrate according to claim 25, wherein a chromate layer is provided on a surface of the surface treatment layer as a rust proofing layer.

27. The surface treated copper foil provided with a carrier foil for a polyimide resin substrate according to any one of claim 25, wherein a silane coupling agent treatment layer is provided at an outermost layer of a bonding surface of the electro-deposited copper foil in contact with the polyimide resin substrate.

28. The surface treated copper foil provided with a carrier foil for a polyimide resin substrate according to claim 25, wherein the silane coupling agent treatment layer is formed of an amino silane coupling agent or a mercapto silane coupling agent.

29. A flexible copper-clad laminate obtained by directly laminating the surface treated copper foil according to claim 1 and a polyimide resin substrate.

30. A flexible copper-clad laminate obtained by directly laminating the surface treated copper foil according to claim 6 and a polyimide resin substrate.

31. A flexible copper-clad laminate obtained by directly laminating the surface treated copper foil according to claim 11 and a polyimide resin substrate.

32. A flexible copper-clad laminate obtained by directly laminating the surface treated copper foil according to claim 16 or a surface treated copper foil provided with a carrier foil and a polyimide resin substrate.

33. A flexible copper-clad laminate obtained by directly laminating the surface treated copper foil provided with a carrier foil according to claim 21 and a polyimide resin substrate.

34. A flexible copper-clad laminate obtained by directly laminating the surface treated copper foil provided with a carrier foil according to claim 25 and a polyimide resin substrate.

35. A film carrier tape for TAB obtained by directly laminating the surface treated copper foil according to claim 1 and a polyimide resin tape.

36. A film carrier tape for TAB obtained by directly laminating the surface treated copper foil according to claim 6 and a polyimide resin tape.

37. A film carrier tape for TAB obtained by directly laminating the surface treated copper foil according to claim 11 and a polyimide resin tape.

38. A film carrier tape for TAB obtained by directly laminating the surface treated copper foil according to claim 16 and a polyimide resin tape.

39. A film carrier tape for TAB obtained by directly laminating the surface treated copper foil provided with a carrier foil according to claim 21 and a polyimide resin tape.

40. A film carrier tape for TAB obtained by directly laminating the surface treated copper foil provided with a carrier foil according to claim 25 and a polyimide resin tape.
